(19) United States
(12) Patent Application Publication
(10) Pub. No.: US 2024/0196857 A1
(43) Pub. Date: Jun. 20, 2024

(54) Pet Crate and House

(71) Applicants: Waheeda Butler, Meridian, ID (US); Joshua Neal Butler, Meridian, ID (US)

(72) Inventors: Waheeda Butler, Meridian, ID (US); Joshua Neal Butler, Meridian, ID (US)

(21) Appl. No.: 18/530,038

(22) Filed: Dec. 5, 2023

Related U.S. Application Data
(60) Provisional application No. 63/476,345, filed on Dec. 20, 2022.

(51) Int. Cl. A01K 1/03; A01K 1/01

(52) U.S. Cl. CPC A01K 1/033; A01K 1/0107

(57) ABSTRACT

A collapsible pet carrier having a removable liner. The liner is waterproof and extends around the inside of the carrier, and preferably on the ceiling of the crate as well. The liner prevents pet urine and feces from reaching the walls of the collapsible pet carrier. The floor and walls of the liner can be configured with flaps that extend outward from the carrier, and can be folded back into the carrier. This assists with male pets that urinate by the pet lifting its leg and spraying on the walls of the insert. The liner attaches to the inner surface of the walls of the pet carrier and is removable to facilitate cleaning the liner.

### CROSS-REFERENCE TO RELATED APPLICATIONS

This application claims the benefit of U.S. Provisional Application No. 63/476,345, filed Dec. 20, 2022, the disclosure of which is incorporated by reference.

### TECHNICAL FIELD

The disclosure generally relates to a pet carrier configured with a removable, washable liner for controlling pet waste, including a pet crate configurable for attachment to a larger pet house.

### BACKGROUND OF THE INVENTION

Portable, collapsible pet carriers are often used to transport small and medium sized pets, such as s. The collapsible pet carriers are generally a rectangular shape having zippered entrances on either side of the rectangular prism. Often absorbent materials, such as absorbent pads are placed at the bottom of the portable carrier to collect pet waste that accumulates at the bottom of the crate. Often the portable crates are utilized in apartment type settings, office buildings, and other locations where it difficult to take the pet outside to relieve itself.

One common absorbent pad is called the Wee-Wee Pad®. The Wee-Wee Pad® is a generally flat, absorbent pad that is positioned at the bottom of the crate. The animal relieves itself on the pad and subsequently the pad is removed and discarded. One issue with the pad is that it is flat and thus for male dogs that lift their legs, the pad often does not trap all of the urine. Further, if the pet is close to the side walls of the crate, the pet may defecate on the side wall of the crate. While the crate covering is typically a removable, washable material. The entire crate must be disassembled or alternatively cleaned while assembled.

Additionally, indoor pet house assemblies have been developed, such as pet cabanas, for smaller dogs. The pet cabana provides smaller and medium size pets with their own “private” area within a house. Often the pet or pet caretaker positions an absorbent pad within the pet house. However, the absorbent pads can be difficult to remove as the pet caretaker sometimes must crawl into the pet house to remove the pad. What is needed is a detachable mechanism to allow the carrying crate that a pet is familiar with relieving itself in that can be easily detached from the pet house for cleaning.

### SUMMARY

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined herein.

What is disclosed is a collapsible crate having a removable liner that extends up the side walls of the crate. The liner forms a waterproof barrier as an enclosed stall that prevents pet waste from reaching the soft fabric of the collapsible crate. The collapsible crate is configured to collapse or fold from an open position to a collapsed storage position. A soft fabric material, such as canvas or nylon, is attached to the collapsible frame and defines an internal compartment of the collapsible crate when the collapsible crate is in an extended position.

The crate can have one or more doors and optional windows. Preferably the door(s) are closable, such as with a zipper, to allow the collapsible crate to serve as a travel crate. The removeable liner is configured to attach to the interior of the pet crate. For example, the removeable liner can be configured to attach to the interior of the pet crate by a connector, such as rivets, snaps, hook and loop fastener, or other attachment mechanism. The liner can be constructed as a one-piece liner or alternatively as a multi-piece liner that is configured to be collapsed or folded for storage, and assembled or extended for use. For example, the liner can be foldable so as to be folded flat for storage and/or transport. The liner can have extender flaps that extend beyond the crate door. The extender flaps can be configured to be foldable so that when the crate is transported, the extender flaps fold into the crate and attach to the portion of the liner within the crate.

In a preferred embodiment, the fluid impenetrable liner has a series of hook and loop fastener strips attached to an underside of the liner. The interior of the crate has a series of corresponding hook and loop fasteners configured for mating engagement with the hook and loop fasteners of the insert.

The insert side wall extends upward along the interior side of the walls of the crate. Preferably the liner extends to the ceiling of the crate, however the liner can be configured to extend halfway or more up the inner surface of the walls of the crate. In a typical pet crate, the entry and exit doors of the portable crate have a threshold that the pet must step over to enter to crate. Preferably the liner has a lip that is configured to extend over this threshold and to be secured to the threshold by the fastener, such as corresponding hook and loop strips.

For use in rectangular prism crates, the liner is preferably configured with three walls and a floor. The walls are two opposing side walls and a back wall. This arrangement provides an enclosed stall with a door or open front for pet ingress and egress. A ceiling can also be used. Preferably the two sides and the back wall connect by fastener, such as a snap fastener or hook and loop fastener. This connection allows the side walls and back walls to be detached from one another, and folded into a flat configuration. The side walls have material overlap that facilitates the water resistance of the insert by overlapping the material across seams. This connector flap overlaps such that liquid that is sprayed on the side wall or back wall flows down to the insert floor, and does not leak behind the insert.

The side walls and/or floor can each have an extender flap that extends beyond the door of the collapsible crate. These extender flaps are configured to extend beyond the door and attach to form a U-shape or U-shape with a roof to form a tunnel. The extender flaps are configured to be rigid or semi-rigid so as to be freestanding when extending beyond the door of the pet crate. The extender flaps particularly assist with male dogs, which often lift the leg for urinating, by providing additional waste collection area.

In a preferred embodiment, an improved pet crate is provided that is configured to attach to a larger pet house, such as pet cabana. In a preferred embodiment, the pet crate has a door for ingress and egress formed in a side wall of the crate. The door is framed by the side wall such that the door does not occupy the entire side wall of the crate. Preferably, a series of connectors, such as snap connectors, are positioned along the side wall surrounding the door. The pet cabana or pet house has a series of connectors positioned along a door or other entry way to allow for egress into and out of the pet house. The connectors are configured for mating engagement with the connectors of the door wall of the pet crate. Preferably a tunnel is configured that connects to the connectors of the crate as well as to the connectors to the pet house. The connectors are configured to allow for easy human disengagement to allow for access to the crate to allow for cleaning of a liner or absorbent pad positioned in the crate.

In a further embodiment the insert is formed in the shape of a foldable cube having an open side or a door installed in one side. The exterior of the cube is attachable to the interior faces of the walls of the pet crate, similar to the embodiments described above, by a variety of mechanisms such as hook and loop fastener, snap fastener, or other releasable fastener.

Still other features and advantages of the presently disclosed and claimed inventive concept(s) will become readily apparent to those skilled in this art from the following detailed description describing preferred embodiments of the inventive concept(s), simply by way of illustration of the embodiments contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature.

### BRIEF DESCRIPTION OF THE FIGURES

FIG. 1 is a first perspective view of a collapsible pet crate.

FIG. 2A is a second perspective view of a collapsible pet crate.

FIG. 2B is a perspective view of the collapsible pet crate of FIGS. 1 and 2A having a liner having flaps extending out of the collapsible pet crate.

FIG. 3 is a partial perspective view of the interior of the pet crate of FIG. 1.

FIG. 4A illustrates the pet crate of FIGS. 1-3 and a first embodiment of a removable liner.

FIG. 4B illustrates the pet crate of FIGS. 1-3 and a second embodiment of a removable liner.

FIG. 4C illustrates the pet crate liner of FIG. 4C with one flap of the removable liner folded inward.

FIG. 5 is a perspective view of the first embodiment of the removable liner.

FIG. 6 is a perspective view of the first embodiment of the removable liner in a flat orientation.

FIG. 7 illustrates an embodiment of a connection for connecting the walls of the liner to assemble the liner from the flat orientation of FIG. 6 to the orientation of a liner shown in FIG. 4A.

FIG. 8 illustrates an embodiment of a liner having a camera mount.

FIG. 9 illustrates the liner and pet crate of FIG. 4A with the liner partially assembled in the collapsible crate.

FIG. 10 illustrates the collapsible crate of FIG. 1 with a tunnel extension.

FIG. 11 illustrates the collapsible crate and tunnel extension of FIG. 10 attached to a pet house.

### DETAILED DESCRIPTION OF THE FIGURES

In the following description and in the figures, like elements are identified with like reference numerals. The use of “e.g.,” “etc.,” and “or” indicates non-exclusive alternatives without limitation unless otherwise noted. The use of “including” means “including, but not limited to,” unless otherwise noted.

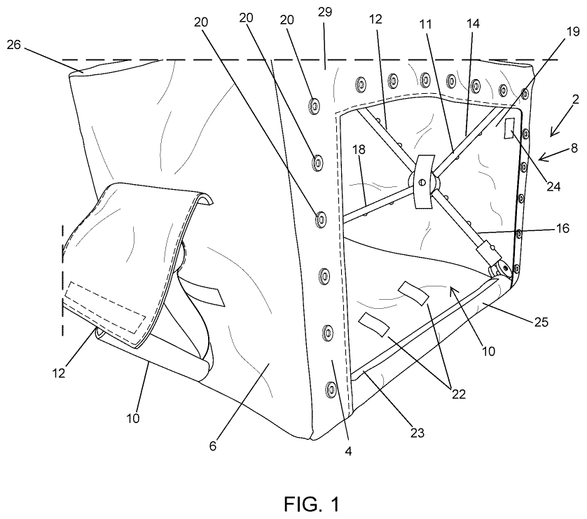

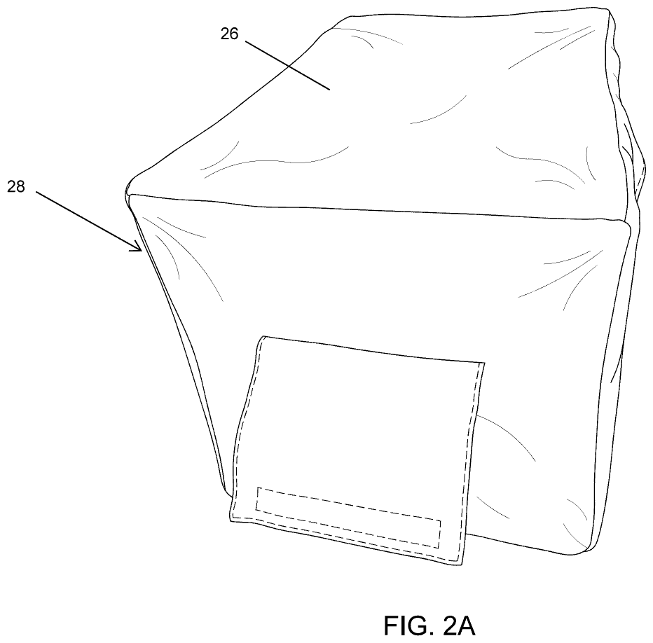

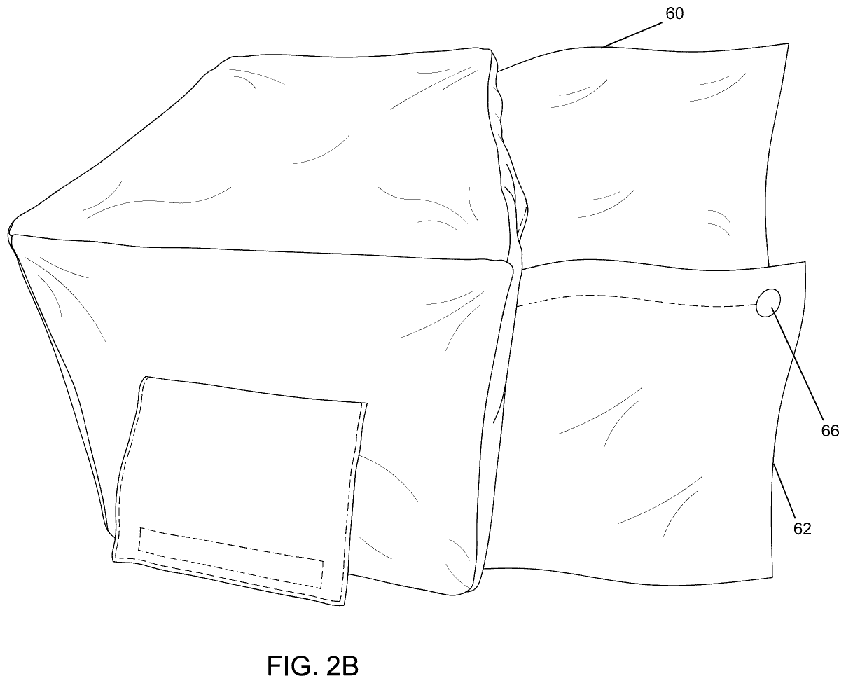

FIG. 1 illustrates a perspective view of a portable, collapsible pet crate. The portable, collapsible pet crate has two opposing side walls 4, 28 (shown in FIG. 2) a top 26, a bottom 10 and two opposing side walls 6, 9. The exterior shell of the crate is typically formed of a flexible material that allows the crate to be collapsible. The frame of the depicted embodiment utilizes two opposing X-shaped end pieces that provide support at each of the opposing side walls. Each of the end sections utilizes a connector segment 12, 14, 16, 18 with each extending to the corner of a side wall. Length wise frame support sections extend length wise along the crate connecting the two opposing collapsible end supports.

The crate defines a box for housing a pet, such as a pet. The floor 10 is typically configured with a waterproof or similar material. In typical use, an absorbent pad is positioned directly on the floor 10. The length wise side wall 4 defines a door opening 8 for ingress and egress of a pet into the portable crate. The side wall defines the opening with the frame 29 of material defining the door opening. The bottom section of the frame provides a threshold 25 over which the animal must step. The threshold is typically comprised of a piece of fabric positioned over or adjacent to the lengthwise frame segment. The side walls 6, 9 of the depicted crate are configured with handles 10 for lifting the crate. In the depicted embodiment the handles have covers 12 for securing the handles when not in use.

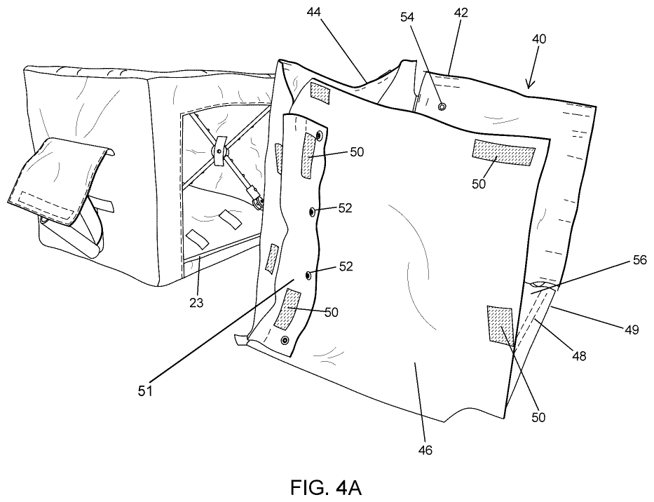

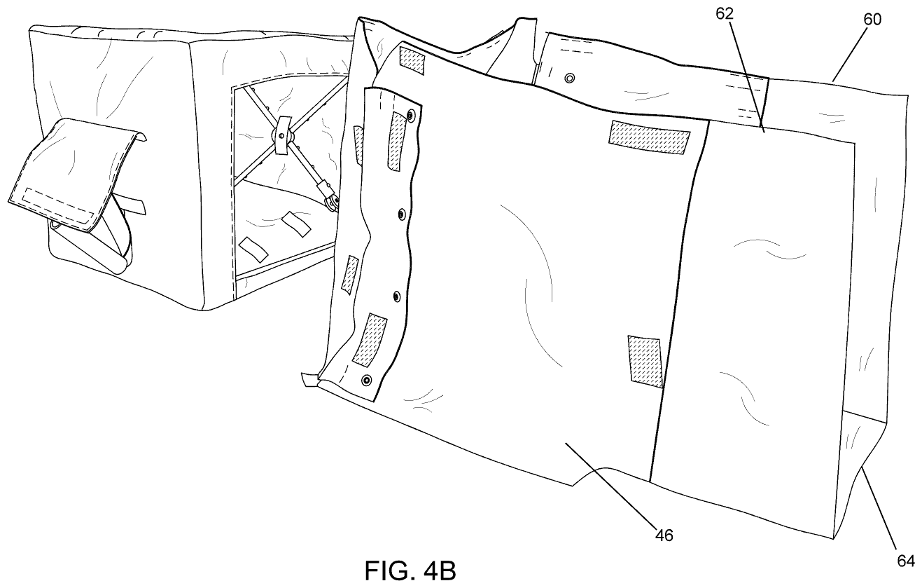

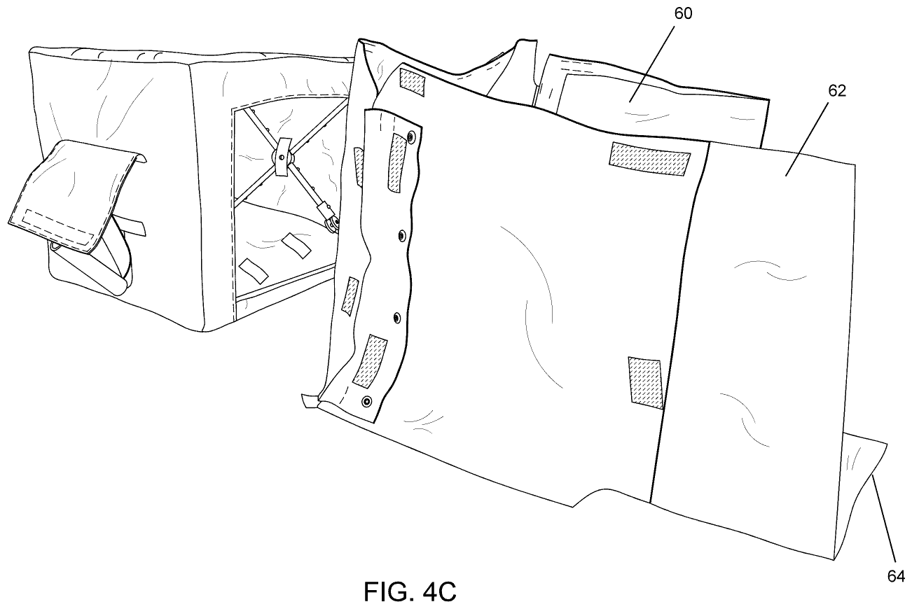

The depicted crate has a series of hook and loop fastener materials 22 positioned on the floor of the plate and a series of hook and loop fastener 24 material positioned on the side walls and back wall (not shown) of the crate. The fastener sections are configured for mating engagement with mating fastener sections positioned on a removeable liner. The removable liner is depicted in FIG. 4. The frame of the door has a series of connectors 20 that are configured for connecting to a tunnel to connect to a larger pet house, such as a pet cabana. Alternatively, the door can connect to a fabric material that forms a tunnel between the door frame of the crate and the pethouse or cabana.

In the depicted embodiment, the liner is positioned within the crate. The liner is configured to extend vertically along the interior of the back wall and side walls of the crate. The liner is configured to be positioned so as to be placed over the threshold or lip of the door. The threshold is shown with hook and loop fastener material 23 configured for releasable attachment to hook and loop fastener on the underside of the insert lip. The liner is constructed of a waterproof, washable material. The liner is configured to extend upward along the walls of the crate to provide a barrier between the pet and the fabric walls of the crate. The liner serves to protect the fabric material by preventing urine and feces from the pet from the fabric walls.

FIG. 2a illustrates a perspective view of the exterior of a preferred embodiment of the crate. The crate has a floor having a front wall, a back wall, and two opposing crate side walls extending up from the crate floor. The front wall can be omitted in some embodiments with the crate door occupying the entire space of the crate front wall, and a crate ceiling connecting the top of each of the walls to form an enclosure.

FIG. 2b illustrates the liner having side wall flaps 60, 62 extending from the door of the crate. The flaps are rigid or semi-rigid, allowing the flaps to be freestanding. The semi-rigid configuration can have a frame utilizing a fabric material, such as nylon or canvas, extending between the frame components. A floor flap (shown as 64 FIG. 4B) extends between the two side wall flaps. The side wall flaps preferably have one or more fasteners to secure the flap to the inner wall of the insert when the flap is folded into the collapsible crate. In the depicted embodiment a magnetic fastener 66 is provided that secures the flap to a corresponding fastener (not shown) positioned in or on the corresponding side wall (46 of FIG. 4b)

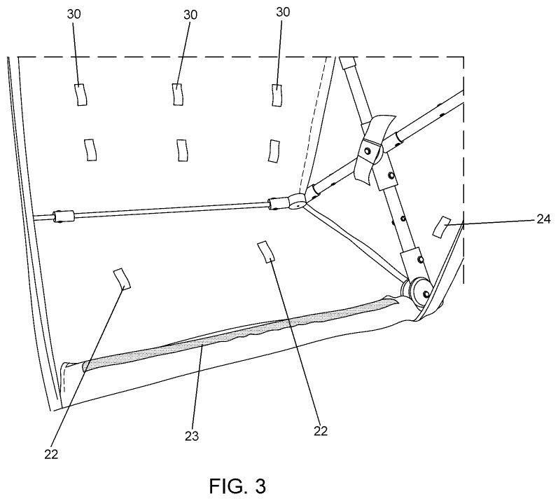

FIG. 3 illustrates an interior view of the crate with the liner removed. A series of hook and loop fastener material 30 is positioned on the interior of the back wall of the crate. The crate can be constructed with one door as shown or alternatively with multiple zippered doors allowing ingress or egress from either side of the crate. The side walls are shown with hook and loop fasteners 24 and the floor of the crate are shown with hook and loop fasteners 22. Hook and loop fastener section 23 is positioned on the threshold, to provide mating engagement with the liner.

FIG. 4A illustrates an embodiment of a liner 40 removed from the crate. The liner is shown with two liner side walls 42, 46 and a back wall 44. The liner has a floor 56 that extends between the two side walls. The liner has a liner back wall 44 that configured to extend upward on the crate back wall. The liner has a series of hook and loop fastener strips that are configured for attaching the liner to the interior of the crate. The liner has a lip 47 that has a hook and loop fasteners strip positioned on the underside of the lip. The hook and loop fastener strip is shown by dashed lines 48. The depicted liner is constructed of three flaps forming the liner back wall and liner side walls. The construction of the flaps allow the liner to be folded easily. A series of connectors 52, 54 connect the back wall to the side walls. Alternatively, the liner can be constructed of a uniform piece that does not separate into individual walls.

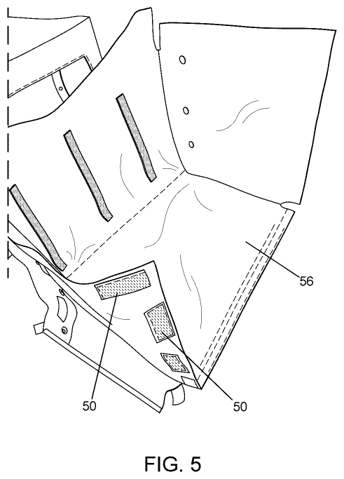

FIG. 5 illustrates a perspective view looking toward the floor of the liner. The liner has a generally rectangular shaped floor. The floor coupled with the liner walls forms a barrier preventing the urine and feces from traveling onto the fabric walls of the crate. The liner back wall 44 has an overlapping flap 51 that overlaps the seam between the side wall 46 and the back wall 44. This overlapping flap increases the water resistance of the liner.

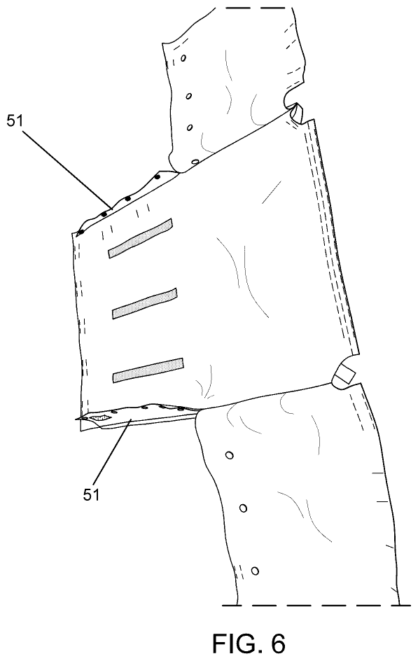

FIG. 6 illustrates an embodiment of the liner having three walls which are disconnected allowing the liner to be in a flat position. Each wall can then be folded onto the floor, providing for a compact storage position. The folded liner can be positioned onto the floor of the crate, and the crate can be folded into its storage position with the liner stored within.

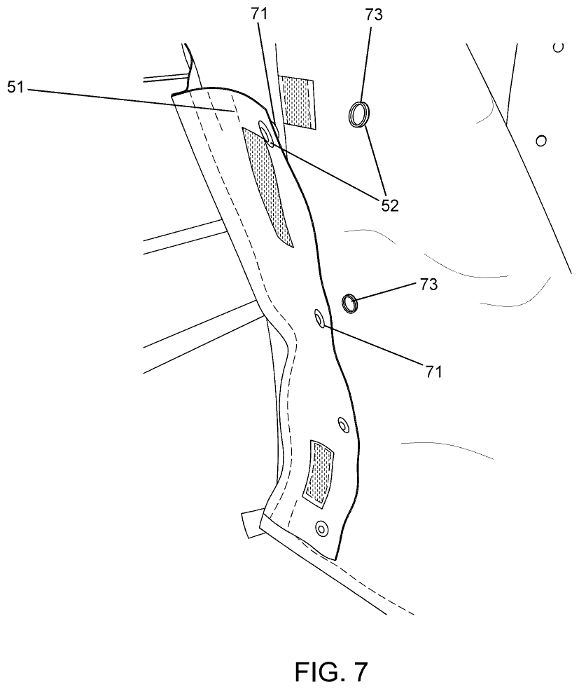

FIG. 7 illustrates the connection of the snap connectors 52 having male connector 71 and female connector 73. Alternatively, a one-piece design can be utilized.

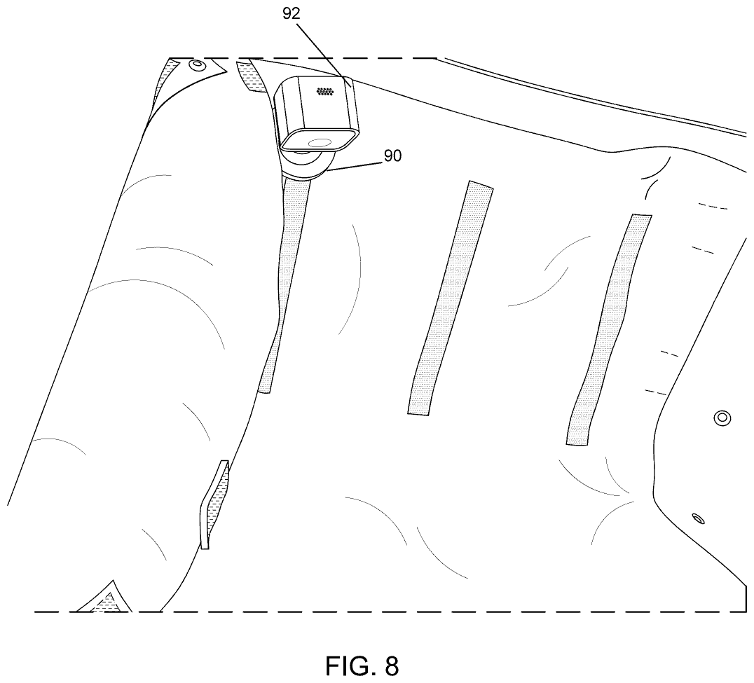

FIG. 8 illustrates the embodiment of the liner having camera mount 90 and camera installed. The camera mount and camera are useful for monitoring the pet while the pet is in the crate. The camera and or camera mount can further utilize one or more speakers such that a pet caretaker can provide positive reinforcement for the pet for utilizing the crate as a pet toilet.

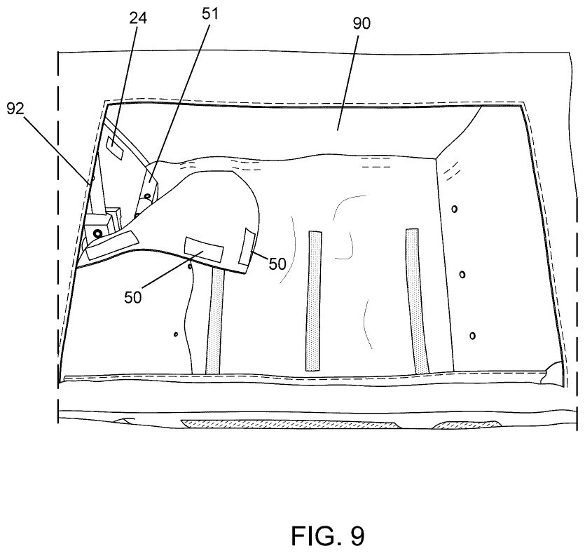

FIG. 9 illustrates a perspective front view looking into the portable crate with the liner partially installed. The left wall of the liner 92 has been folded inward from the top of the liner revealing hook and loop fastener strips 50 on the inside of the left insert wall and corresponding hook and loop fasteners 24 on the crate wall. The side and back liner walls extend to the ceiling 90 of the crate providing maximum protection of the fabric material forming the walls of the crate. In a preferred embodiment, a single non-sectioned piece of material is utilized to provide a single waterproof insert.

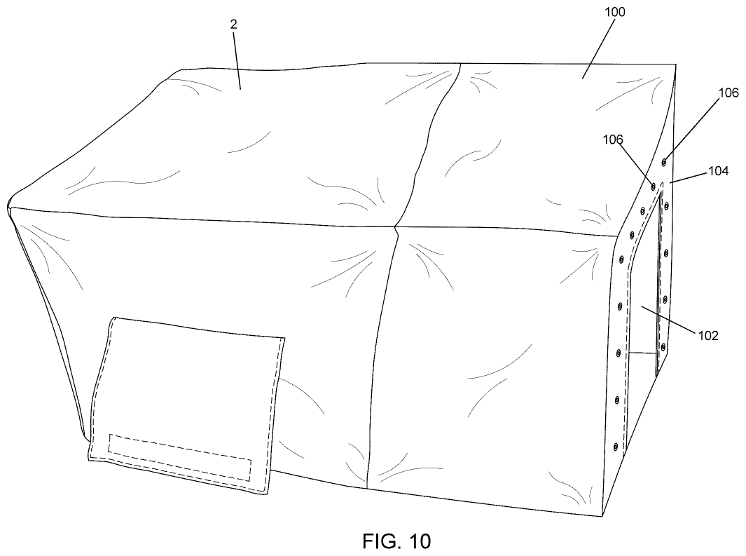

FIG. 10 illustrates the crate 2 connected to a tunnel 100 having tunnel door 102 formed by tunnel wall door frame 104. The door frame has fasteners 106 configured for connecting the tunnel to a larger pet house or pet crate.

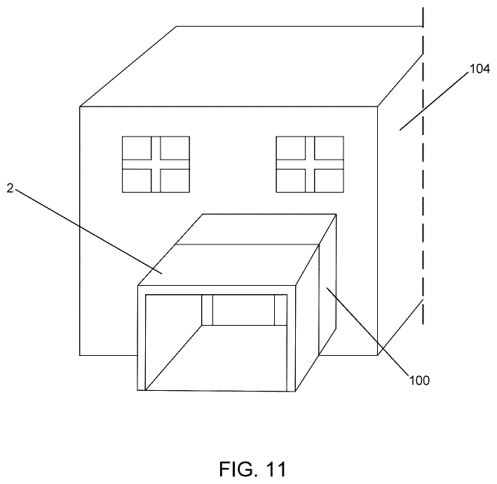

FIG. 11 illustrates a view of the crate having a duel opening side wall with the crate 2 connected to the tunnel 100 and connected to the pet house 104. Alternatively, the pet crate can be affixed directly to the house. The tunnel can be a section of fabric or material that extends between the crate and the house or alternatively be a framed connector.

While certain exemplary embodiments are shown in the Figures and described in this disclosure, it is to be distinctly understood that the presently disclosed inventive concept(s) is not limited thereto but may be variously embodied to practice within the scope of this disclosure. From the foregoing description, it will be apparent that various changes may be made without departing from the spirit and scope of the disclosure as defined herein.

What is claimed is:

1. A collapsible soft crate comprising
a collapsible frame, said frame configured to fold from an assembled position to a folded position;
a soft cover configured to enclose the collapsible frame when said collapsible frame is in said assembled position, said soft cover and collapsible frame being assembled together as a crate assembly comprising a crate floor, crate ceiling, and at least one crate side wall extending between said crate floor and said crate ceiling and supporting said crate ceiling, wherein said crate assembly defining a pet crate interior and a door configured for pet ingress to said pet crate interior; and
a removable washable liner positioned in said pet crate interior and removably attached to said crate side wall, said removable washable liner covering said crate floor and said crate side wall to form an enclosed stall configured for prevention of fluid flow from said enclosed stall to said crate assembly, wherein said removable washable liner is configured to retain pet waste on said removable washable liner.

2. The collapsible soft crate of claim 1 wherein said frame defines a rectangular prism in said extended position, wherein said at least one crate side wall comprises two parallel opposing crate side walls, a crate back wall extending between said two crate side walls, and a crate door positioned opposite said crate back wall and extending between said two side walls, wherein said removable washable liner covers said opposing crate side walls and said crate back wall to form said enclosed stall.

3. The collapsible soft crate of claim 2 wherein said door is positioned within a crate side wall extending between said two opposing side walls.

4. The collapsible soft crate of claim 2 wherein said removable washable liner comprises a rectangular liner floor and two opposing liner side walls with a liner back wall extending between said liner side walls.

5. The collapsible soft crate of claim 4 wherein said two opposing liner side walls are releasably attached to said liner back wall said opposing liner side walls and said liner back wall to fold to a collapsed position.

6. The collapsible soft crate of claim 5 wherein one of said opposing liner side walls and said liner back wall comprises an overlapping flap connected to the other of said opposing liner side walls and said liner back wall to provide a water resistant seam.

7. The collapsible soft crate of claim 6 wherein said overlapping flap is connected to the other of said opposing liner side walls and said liner back wall by snap connections and/or magnetic connections.

8. The collapsible soft crate of claim 1 wherein said removable washable liner is removably attached to said interior of said soft cover by hook and loop fastener.

9. The collapsible soft crate of claim 1 wherein said collapsible soft crate is configured to attach to a pet house.

10. The collapsible soft crate of claim 9 wherein said soft cover comprises a door in said back wall wherein said liner is configured to cover said door.

11. The collapsible soft crate of claim 10 wherein said front wall comprises a plurality of connectors configured to connect to a plurality of connectors surrounding a pet house door on said pet house.

12. The collapsible soft crate of claim 2 wherein each of said opposing liner side doors and said liner floor comprises an extender flap extending through said door, wherein said liner comprises a crate interior liner section and an extender section.

13. The collapsible soft crate of claim 12 wherein each of said extender flaps is foldable to be positioned within said crate.

14. The collapsible soft crate of claim 13 wherein each of said extender flaps comprises a connector for connecting each extender flap to the crater interior liner section.

15. The collapsible soft crate of claim 1 wherein said line comprises a liner lip connected to a crate lip formed by a bottom edge of said door.

16. The collapsible soft crate of claim 1 wherein said liner comprises a single piece of fabric.
